(19) United States
(12) Patent Application Publication
(10) Pub. No.: US 2006/0070213 A1
(43) Pub. Date: Apr. 6, 2006

(54) Cushioned tool handle device

(76) Inventor: Yin Han Huang, Taichung (TW)

Correspondence Address: Yin Han HUANG, P.O. Box 63-298, Taichung, 406, TW

(21) Appl. No.: 10/949,773

(22) Filed: Sep. 27, 2004

(51) Int. Cl. B25G 1/10

(52) U.S. Cl. 16/431

(57) ABSTRACT

A cushioned tool handle device includes a handle having a channel to receive one end of a tool member and having one or more orifices, the tool member includes one or more apertures aligned with the orifices of the handle to receive fastener pins which may secure the tool member to the handle. An outer cushioning sleeve is attached onto an outer peripheral portion of the handle, to enclose the orifices of the handle, and to stably retain the fastener pins within the orifices of the handle. Each fastener pin includes an extension having an outer diameter smaller than that of the fastener pin, to form a peripheral shoulder and to engage with the tool member, and to solidly secure the tool member to the handle.

### BACKGROUND OF THE INVENTION

1. Field of the Invention

The present invention relates to a tool handle device, and more particularly to a cushioned tool handle device having a solidly coupling or securing structure and simultaneously having a cushioning structure.

2. Description of the Prior Art

Typical tool devices, such as wrenches, screw drivers, hammers, knives, saws, etc. comprise a tool member secured to handle device, for being rotated or driven by the handle device.

For example, U.S. Pat. No. 1,376,811 to Hood discloses one of the typical tool handle devices including two handle casing members to be secured together by fasteners or rivets. However, the rivets may be exposed, and the typical tool handles do not include any cushioning structure for cushioning purposes.

U.S. Pat. No. 3,189,069 to Stowell discloses another typical tool handles including resilient gripping means, and including a tool shank detachably coupled to a handle body with nibs or the like. The typical tool handles include a cushioning structure for cushioning purposes. However, the tool shank may not be solidly coupled or secured to the handle body and may be easily become loose relative to the handle body.

U.S. Pat. No. 4,825,552 to Bendickson et al. discloses a further typical knife handle including resilient gripping member molded onto one end of a knife blade. However, the molded resilient gripping member tool shank may not be solidly coupled or secured to the knife blade and may be easily become loose or brocken relative to the handle body.

U.S. Pat. No. 4,837,892 to Lo discloses a still further typical cushioned handle structure including an elastomeric material integrally formed as an overlay in contact with an outer surface and integrally secured on a handle. However, the typical cushioned handle structure do not include a securing structure to solidly secure a tool member to the handle.

The present invention has arisen to mitigate and/or obviate the afore-described disadvantages of the conventional cushioned tool handles.

### SUMMARY OF THE INVENTION

The primary objective of the present invention is to provide a cushioned tool handle device including a solidly coupling or securing structure and simultaneously including a cushioning structure.

In accordance with one aspect of the invention, there is provided a cushioned tool handle device comprising a handle including a channel formed therein and opened in one end thereof, and including at least one orifice laterally formed therein and communicating with the channel thereof, a tool member including a first end engaged into the channel of the handle, and including at least one aperture formed therein and aligned with the orifice of the handle, at least one fastener pin engaged into the orifice of the handle and the aperture of the tool member, to secure the tool member to the handle, and an outer cushioning sleeve attached onto an outer peripheral portion of the handle, to enclose the orifice of the handle, and to stably retain the fastener pin within the orifice of the handle.

The handle includes a peripheral recess formed in the outer peripheral portion thereof and communicating with the orifice thereof, to receive the outer cushioning sleeve. The handle includes at least one peripheral shoulder defined by the peripheral recess thereof, to engage with the outer cushioning sleeve and to stably retain the outer cushioning sleeve in the peripheral recess of the handle.

The fastener pin includes two ends, and the outer cushioning sleeve is contacted with the ends of the fastener pin, to stably retain the fastener pin in the orifice of the handle.

The fastener pin includes an extension extended therefrom and having an outer diameter smaller than that of the fastener pin, to form a peripheral shoulder therein, and to engage with the tool member, and thus to solidly secure the tool member to the handle.

The orifice of the handle is a stepped orifice to receive the fastener pin and the extension thereof. The fastener pin includes a stud extended from the extension thereof and having an outer diameter smaller than that of the extension.

The handle includes a second orifice laterally formed therein and communicating with the channel thereof, the tool member includes a second aperture formed therein and aligned with the second orifice of the handle, and a second fastener pin engaged into the second orifice of the handle and the second aperture of the tool member, to secure the tool member to the handle.

The second fastener pin includes two ends, and the outer cushioning sleeve is contacted with the ends of the second fastener pin, to stably retain the second fastener pin in the second orifice of the handle.

The second fastener pin includes an extension extended therefrom and having an outer diameter smaller than that of the second fastener pin, to form a peripheral shoulder therein, and to engage with the tool member, and thus to solidly secure the tool member to the handle. The second orifice of the handle is a stepped orifice to receive the second fastener pin and the extension thereof.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a cushioned tool handle device in accordance with the present invention;

FIG. 2 is a perspective view of the cushioned tool handle device;

FIG. 3 is a perspective view of the cushioned tool handle device, similar to FIG. 2, in which an outer cushioning sleeve is removed for showing an inner structure of the tool handle device; and

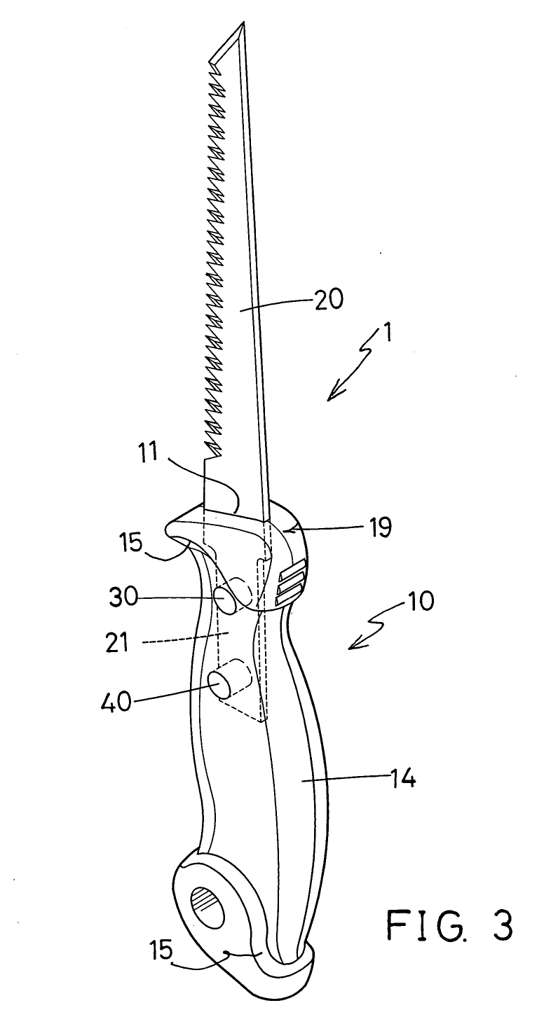

FIG. 4 is a cross sectional view of the cushioned tool handle device, taken along lines 4-4 of FIG. 2.

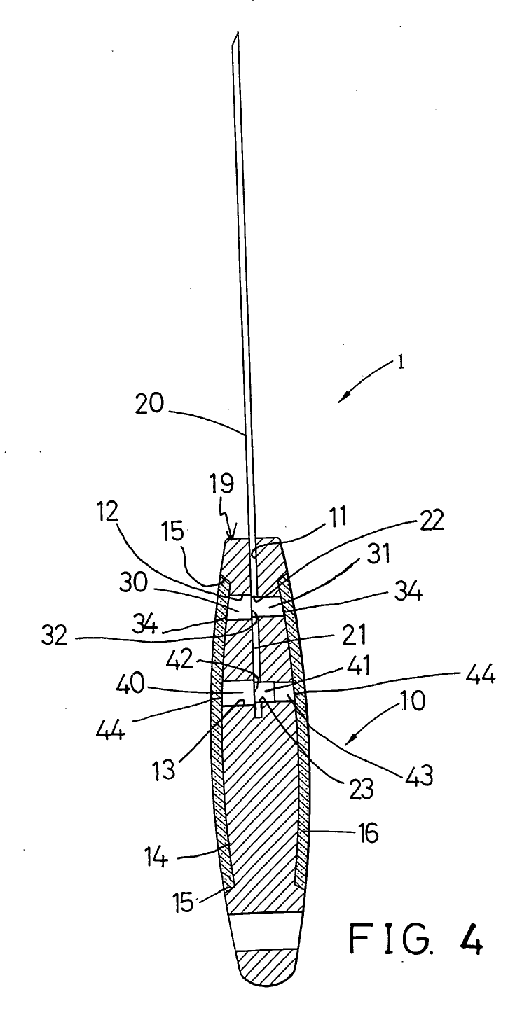

### DETAILED DESCRIPTION OF THE PREFERRED EMBODIMENT

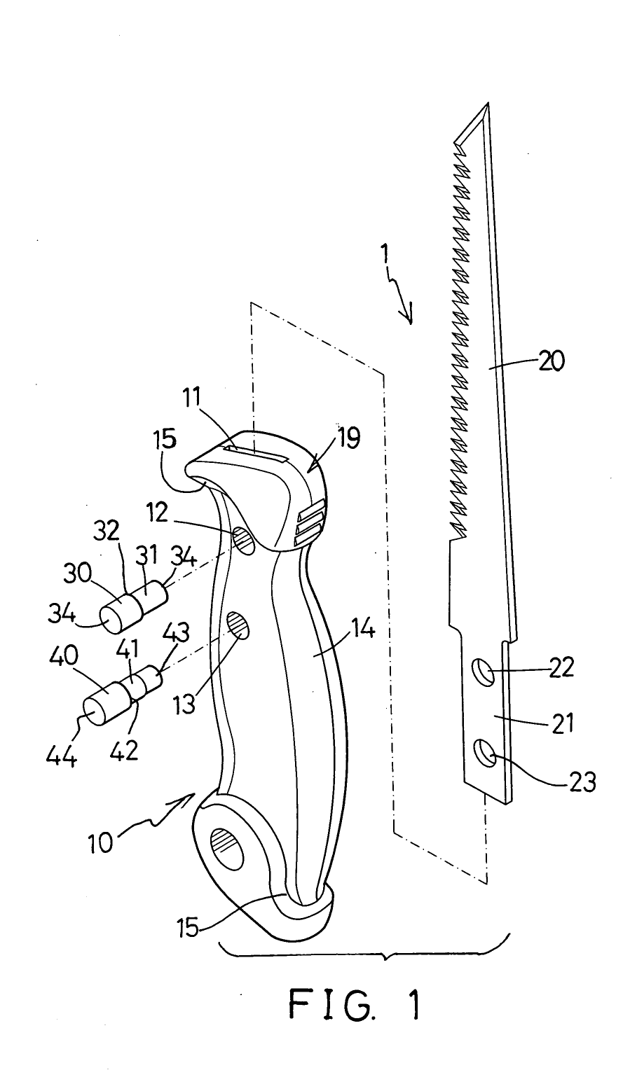

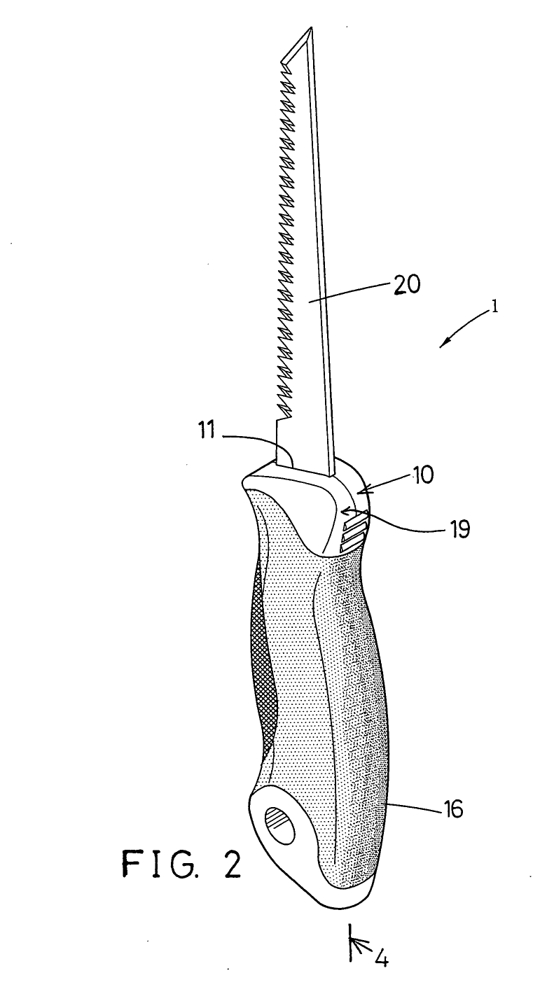

Referring to the drawings, and initially to FIGS. 1 and 2, a cushioned tool handle device 1 in accordance with the present invention comprises a handle 10 including a channel 11 longitudinally formed therein and opened in one end 19 thereof for receiving one end 21 of a tool member 20, such as a saw blade 20, and including one or more, such as two stepped orifices 12, 13 laterally formed therein and located closed to the one end 19 thereof, and intersecting or communicating with the channel 11 thereof.

The tool member 20 also includes one or more, such as two apertures 22, 23 laterally formed therein and aligned with the stepped orifices 12, 13 of the handle 10 respectively, for receiving latch or fastener pins 30, 40 respectively, and for solidly securing the tool member 20 to the handle 10.

The handle 10 includes a peripheral recess 14 formed in the outer peripheral portion thereof and communicating with the orifices 12, 13 of the handle 10, for forming or defining one or more peripheral shoulders 15 in the handle 10. An outer cushioning sleeve 16 may then be attached onto or molded onto the outer peripheral portion of the handle 10, to enclose or to block the orifices 12, 13 of the handle 10, and thus to stably shield and retain the fastener pins 30, 40 within the orifices 12, 13 of the handle 10 respectively.

It is preferable that the outer cushioning sleeve 16 is attached onto the outer peripheral portion of the handle 10 and retained or received in the peripheral recess 14 of the handle 10 with such as molding or mold injection processes, and may be engaged with the peripheral shoulders 15 of the handle 10, and may thus include an outer peripheral surface flush with the outer peripheral surface of the handle 10, to allow the outer cushioning sleeve 16 to be stably retained in the peripheral recess 14 of the handle 10.

Each of the fastener pins 30, 40 includes an extension 31, 41 extended therefrom and having an outer diameter smaller than that of the fastener pins 30, 40 respectively, to form a peripheral shoulder 32, 42 therein, and thus to stably engage in the corresponding stepped orifices 12, 13 of the handle 10. It is preferable that the tool member 20 is engaged with the fastener pins 30, 40 and/or engaged with the peripheral shoulder 32, 42 of the fastener pins 30, 40, to allow the tool member 20 to be solidly secured to the handle 10, and to prevent the tool member 20 from being moved laterally relative to the handle 10.

One of the fastener pins 40 may further include a stud 43 extended from the extension 41 thereof, and having an outer diameter further smaller than that of the extension 41 thereof, to allow the fastener pin 40 to be further stably engaged in the corresponding stepped orifice 13 of the handle 10. It is further preferable that the outer cushioning sleeve 16 is engaged or contacted with the ends 34, 44 of the fastener pins 30, 40, to stably retain the fastener pins 30, 40 within the orifices 12, 13 of the handle 10, and to prevent the fastener pins 30, 40 from being moved laterally relative to the handle 10.

Accordingly, the cushioned tool handle device in accordance with the present invention includes a tool member solidly secured to the handle with one or more fastener pins, and an outer cushioning sleeve attached onto the outer peripheral portion of the handle, to stably retain the fastener pins within the orifices of the handle respectively.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cushioned tool handle device comprising:
a handle including a channel formed therein and opened in one end thereof, and including at least one orifice laterally formed therein and communicating with said channel thereof,
a tool member including a first end engaged into said channel of said handle, and including at least one aperture formed therein and aligned with said at least one orifice of said handle,
at least one fastener pin engaged into said at least one orifice of said handle and said at least one aperture of said tool member, to secure said tool member to said handle, and
an outer cushioning sleeve attached onto an outer peripheral portion of said handle, to enclose said at least one orifice of said handle, and to stably retain said at least one fastener pin within said at least one orifice of said handle.

2. The cushioned tool handle device as claimed in claim 1, wherein said handle includes a peripheral recess formed in said outer peripheral portion thereof and communicating with said at least one orifice thereof, to receive said outer cushioning sleeve.

3. The cushioned tool handle device as claimed in claim 2, wherein said handle includes at least one peripheral shoulder defined by said peripheral recess thereof, to engage with said outer cushioning sleeve and to stably retain said outer cushioning sleeve in said peripheral recess of said handle.

4. The cushioned tool handle device as claimed in claim 1, wherein said at least one fastener pin includes two ends, and said outer cushioning sleeve is contacted with said ends of said at least one fastener pin, to stably retain said at least one fastener pin in said at least one orifice of said handle.

5. The cushioned tool handle device as claimed in claim 1, wherein said at least one fastener pin includes an extension extended therefrom and having an outer diameter smaller than that of said at least one fastener pin, to form a peripheral shoulder therein, and to engage with said tool member, and thus to solidly secure said tool member to said handle.

6. The cushioned tool handle device as claimed in claim 5, wherein said at least one orifice of said handle is a stepped orifice to receive said at least one fastener pin and said extension thereof.

7. The cushioned tool handle device as claimed in claim 5, wherein said at least one fastener pin includes a stud extended from said extension thereof and having an outer diameter smaller than that of said extension.

8. The cushioned tool handle device as claimed in claim 1, wherein said handle includes a second orifice laterally formed therein and communicating with said channel thereof, said tool member includes a second aperture formed therein and aligned with said second orifice of said handle, and a second fastener pin engaged into said second orifice of said handle and said second aperture of said tool member, to secure said tool member to said handle.

9. The cushioned tool handle device as claimed in claim 8, wherein said second fastener pin includes two ends, and said outer cushioning sleeve is contacted with said ends of said second fastener pin, to stably retain said second fastener pin in said second orifice of said handle.

10. The cushioned tool handle device as claimed in claim 8, wherein said second fastener pin includes an extension extended therefrom and having an outer diameter smaller than that of said second fastener pin, to form a peripheral shoulder therein, and to engage with said tool member, and thus to solidly secure said tool member to said handle.

11. The cushioned tool handle device as claimed in claim 10, wherein said second orifice of said handle is a stepped orifice to receive said second fastener pin and said extension thereof.
